(19) United States
(12) Patent Application Publication
(10) Pub. No.: US 2009/0292535 A1
(43) Pub. Date: Nov. 26, 2009

(54) SYSTEM AND METHOD FOR SYNTHESIZING MUSIC AND VOICE, AND SERVICE SYSTEM AND METHOD THEREOF

(75) Inventor: Moon-Jong Seo, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignees: Moon-Jong SEO, Seoul (KR); P & IB CO., LTD., Seoul (KR)

(21) Appl. No.: 11/814,194

(22) PCT Filed: Jan. 17, 2006
(86) PCT No.: PCT/KR06/00170

§ 371 Date: Jul. 18, 2007

(30) Foreign Application Priority Data
Jan. 18, 2005 (KR) 10-2005-0004609
Jan. 9, 2006 (KR) 10-2006-0002103

(51) Int. Cl. G10L 19/14; G06F 17/00

(52) U.S. Cl. 704/225; 700/94; 704/E19.001

(57) ABSTRACT

The present invention relates to a system and a method for synthesizing music and voice, and a service system and a service method using the same. The system and method according to the present invention is capable of making a listener feel maximum synthesizing effects to mix the voice and the music. Also, the system and method according to the present invention is capable of synthesizing the voice and music with various effects without the professional synthesizer's volume control.

### TECHNICAL FIELD

The present invention relates to a system and a method for synthesizing music and voice, and a service system and a service method using the same.

### BACKGROUND ART

Generally, in a conventional music mail service, a user selects music to be transmitted to a receiver and sends only the selected music to the receiver. However, this simple music transfer is not satisfactory to sender's various desires.

### DISCLOSURE

### Technical Problem

An object of the present invention is to provide a system and a method capable of providing a music mail with sender's voice and making it easy to grasp the music mail from the sender without loss of the clarity, similar to a multimedia such as disk jockey broadcasting.

Another object of the present invention is to provide a system and a method for controlling a volume level of a synthesized music with various synthesizing effects based on user's voice.

### Technical Solution

According to the present invention, a system for synthesizing voice and music includes: a receiver for receiving user's voice; a database for storing various music sources; and a synthesizing means for controlling volume of the music stored in the database and for synthesizing the controlled music and the voice according to detection of a voice silent part inputted from the receiver.

### Advantageous Effects

The system and method according to the present invention is capable of making a listener feel maximum synthesizing effects to mix the voice and the music.

Also, the system and method according to the present invention is capable of synthesizing the voice and music with various effects without the professional synthesizer's volume control.

### DESCRIPTION OF DRAWINGS

FIG. 1 is a schematic view of a music mail service system according to the present invention.

FIG. 2 is a graph showing the music and user's voice in time domain.

FIG. 3 is a graph showing a conventional method for synthesizing the music and voice.

FIG. 4 is a graph showing a volume controlled music according to a voice silent part.

FIG. 5 is a graph showing a synthesized sound of the voice and the volume controlled music.

FIG. 6 is a graph showing a music element having a volume control at an ending part.

FIG. 7 is a graph showing a music element having a volume-down control.

FIG. 8 is a graph showing a music element having a volume-up control.

FIG. 9 is a graph showing a music element having the volume-down and volume-up controls.

FIG. 10 is a graph showing a voice separation.

FIG. 11 is a graph illustrating a down point mark of the music.

FIG. 12 is a graph illustrating a synthesis of the music and the separated voice according to an embodiment of the present invention.

FIG. 13 is a block diagram illustrating a synthesizer to mix the voice and music according to the present invention.

FIG. 14 is a flowchart illustrating a synthesizing procedure of the voice and music according to the present invention.

### BEST MODE

According to one aspect of the present invention, there is provided a system for synthesizing voice into music comprising; a receiver for receiving the voice from a user; a database for storing a plurality of music data; and a synthesizing means for controlling a volume of the music according to a silent part of the voice and for synthesizing the received voice into the volume controlled music.

According to another aspect of the present invention, there is provided a system for synthesizing voice into music comprising; a receiver for receiving the voice from a user; a database for storing a plurality of music data; and a synthesizing means for separating the received voice into a plurality of voice elements according to a silent part of the voice and synthesizing the separated voice elements into the music.

According to further aspect of the present invention, there is provided a system for synthesizing voice into music comprising; a receiver for receiving the voice from a user; a database for storing individually separated music elements which form the music; and a synthesizing means for synthesizing the received voice into the separated music elements.

According to still further aspect of the present invention, there is provided a system for synthesizing voice into music comprising; a receiver for receiving the voice from a user; a database for storing individually separated music elements which form the music; and a synthesizing means for separating the received voice into a plurality of voice elements according to a silent part of the voice and synthesizing the separated voice elements and the separated music elements.

According to still further aspect of the present invention, there is provided a method for synthesizing voice into music comprising the steps of: a) receiving the voice from a user; b) detecting a silent part of the received voice; c) controlling a volume of the music according to the detected silent part; d) synthesizing the volume-controlled music and the received voice; and e) transmitting the synthesized music and voice.

According to still further aspect of the present invention, there is provided a method for synthesizing voice into music, comprising the steps of: a) receiving the voice from a user; b) detecting a silent part of the received voice; and c) according to the detected silent part, synthesizing the received voice into a plurality of music elements which form the music.

According to still further aspect of the present invention, there is provided a method for synthesizing voice into music, comprising the steps of: a) receiving the voice from a user; b) detecting a silent part of the received voice; c) separating the received voice into a plurality of voice elements according to the detected silent part and; d) synthesizing the separated voice elements and into the music.

According to still further aspect of the present invention, there is provided a method for synthesizing voice into music, comprising the steps of: a) receiving the voice from a user; b) detecting a silent part of the received voice; c) separating the received voice into a plurality of voice elements according to the detected silent part; and d) synthesizing the separated voice elements into a plurality of music elements which form the music.

Hereinafter, the preferred embodiments of the present invention will be described in detail referring to the accompanying drawings.

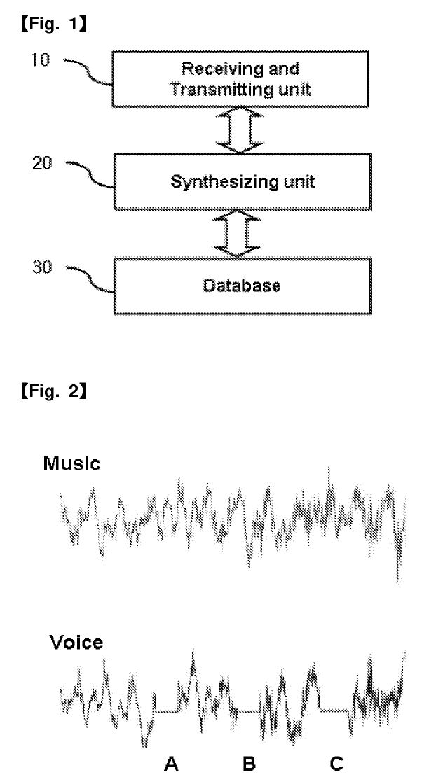

As illustrated in FIG. 1, the present invention includes a receiving and transmitting unit (10), a synthesizing unit (20) and a database (30).

The receiving and transmitting unit (10) is coupled to internet, a mobile communication network, or a telecommunication network. It receives user's voice and transmits a synthesized sound of the music and voice to a specific recipient.

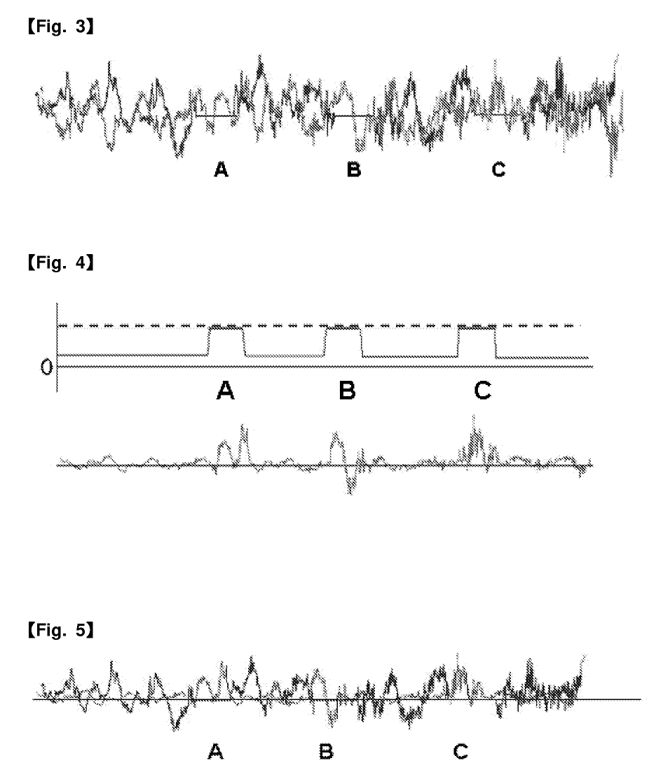

A synthesis unit (20) synthesizes the received voice and the music selected by the user. Here, the synthesis does not mean a mere integration. As illustrated in FIG. 2, the mere integration of music and voice produces a problem of cutting in half the original merit of the synthesis because it is not possible to comprehend the synthesized sound of the of music and voice as illustrated in FIG. 3. Therefore, as illustrated in FIG. 4, the present invention detects a voice silent part and controls a music volume according to the voice silent part and a voice existing part, thereby carrying out the synthesis as illustrated in FIG. 5. Referring to again FIG. 5, the voice silent part triggers music volume up and the voice existing part triggers music volume down for the clarity of the message delivered to a listener. Further, the voice can be separated into a plurality of voice elements based on the voice silent parts (parts A, B and C in FIG. 2). Such a separated voice element can be synthesized into a previously separated music element and the length of the voice silent parts (A, B and C) can be controlled in compliance with the introduction and the end of the music.

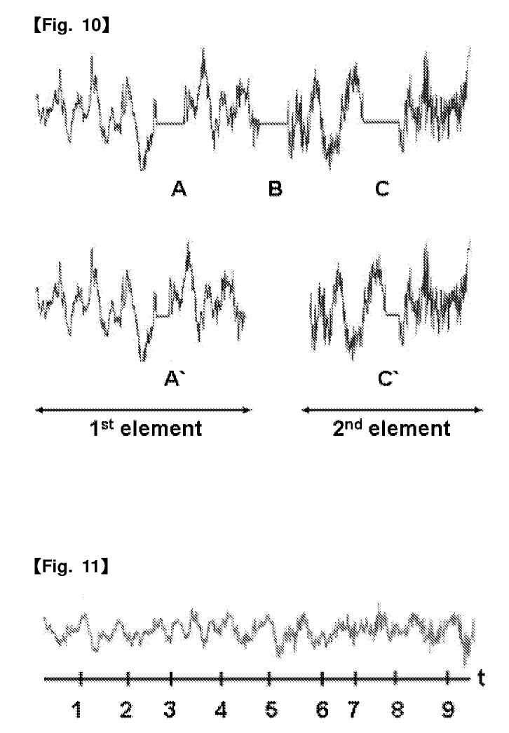

Before synthesizing the voice and the music, the synthesis unit (20) can separate the voice into a plurality of voice elements according to the voice silent parts. For instance, the voice separation for the plurality of voice elements can be performed based on a voice silent part of which a time period is more than 1 second. Also, the whole length of the voice can be divided by the voice silent part. For instance, when the entire input voice has the period of 30 seconds, the voice can be divided into two voice elements, front and rear voice elements, based on a voice silent part near by a 15-second length of the input voice. At this time, when one of the front or rear voice elements has a blank (voice silent part) which is over the reference duration, the length of the blank can be reduced as illustrated in FIG. 10.

During the communication, many noises can be produced and inputted. To erase such noises, a method for erasing a white noise (which created during the entire voice input), such as a circuit noise, or filtering off other frequencies except for the voice frequency can be used to accept clear voice source.

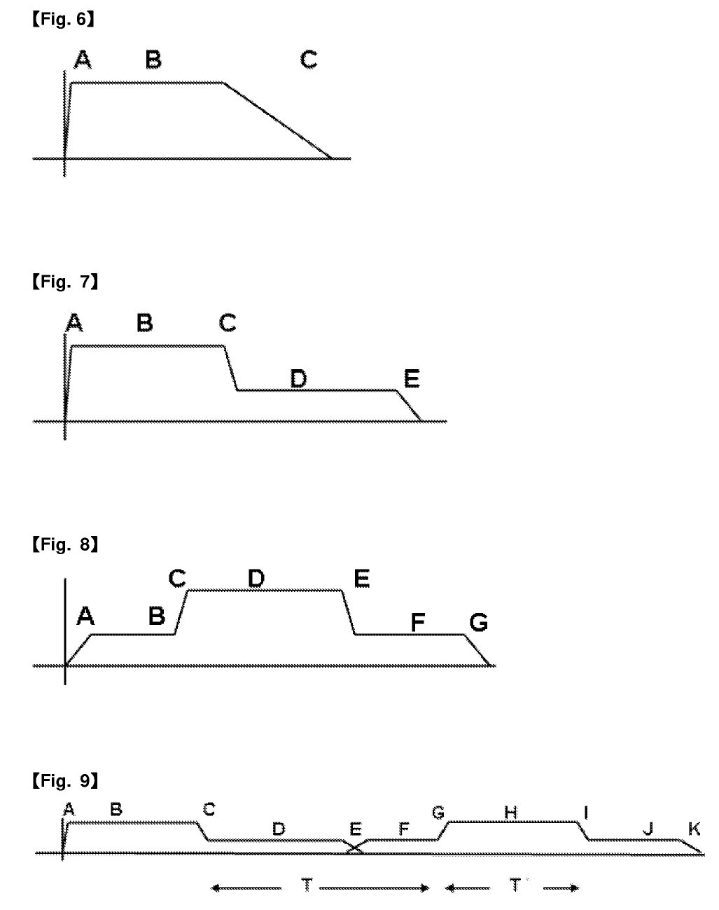

A database (30) stores many musical data. As illustrated in FIGS. 6, 7 and 8, the musical data are comprised of many musical elements. The musical elements can be created automatically based on musical beats, a rhythm, the loudness of the sound, or the beginning part of the singer's voice and they can be created by the user's desires.

FIG. 6 is a graph showing a music element having a volume control at its ending part. Part A is the period of increasing the music volume with the beginning of the voice silent part. Part B is the period of music volume at its highest with no voice and can be an excerpt from the most exciting parts of the music. Part C is the period of decreasing music volume to give an effect on a lingering music for a listener.

FIG. 7 illustrates a volume-down control that can be used as background music when the voice plays. Part A is the period with a stiff increasing slope and can start with the highest volume of 100%. Part B is correspondent to the period of voice silent part (blank). Part C is the period of decreasing the music volume, which is appropriate to a low-pitched sound. The voice elements can be controlled and synthesized to have the voice played at starting points of part C or D. Part D, as a voice part, is a voice activated part. The length of the part D can be controlled by arbitrarily according to the length of the voice part. In case where the music is a background sound of the synthesized sound and the voice is a main sound thereof, part D in FIG. 7 and part A in FIG. 8 are synthesized and the effects of mixing can be maximized by approximately synchronizing the climax part of the music element with an ending part of the voice part. The music background can be controlled by controlling the length of part D in FIG. 7 or part B of the FIG. 8 according to the length of the voice elements. By doing so, the adequate music element can be synthesized into the voice element in the beginning and ending parts thereof. FIG. 8 shows the bridge which can be used when the voice is divided into a plurality of elements.

Referring to FIG. 8, although the voice blanks (parts A, B and C in FIG. 2) does not match well with part D, the effective mixing can be achieved by disposing the divided voice in parts B and F in FIG. 8 of low music volume levels.

Referring to FIG. 9 showing the synthesis of the elements in FIGS. 7 and 8, parts D, E and F are the periods of the active voice elements and parts B and H are the periods of only the music. At time T, the voices are heard with the music on its background and at time T′, only the music is played with no voices.

As described above, the embodiment of the present invention only explains when the music is played on the background but the voice can be played with no background.

Synthesis of the voice can be reserved as the user desires and sent to the designated on the specific date and this synthesis can be applied to coloring, feeling, bell sound, or e-mail service. Service of the present invention through the web can provide basic comments, replays of synthesized the music and voice, and repeat-records of the voice and music.

On the other hand, the music referred in the present invention includes pops, classics, natural sounds, original soundtracks, and all other recorded sounds.

The present invention is focused on the service based on the server but the present invention can be provided through a client-based program. Then, the music can be obtained through the music contents containing servers or be made or purchased by the user.

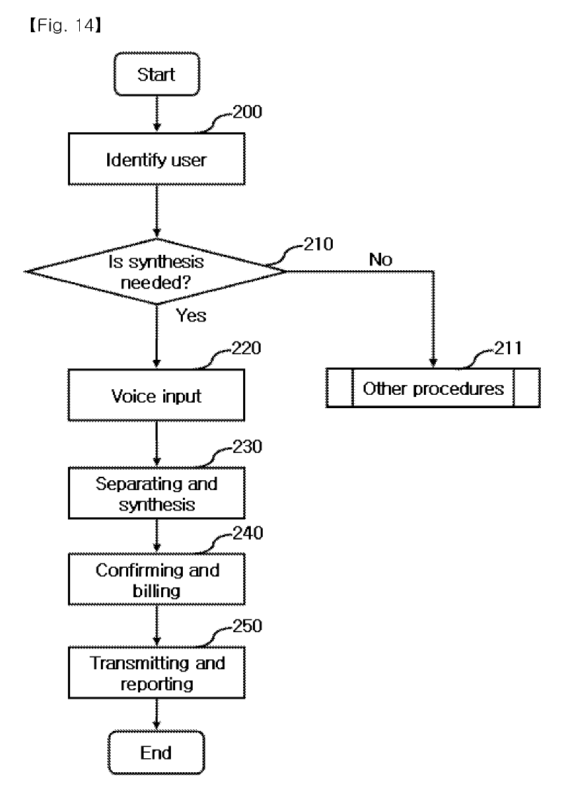

FIG. 13 is a block diagram illustrating a synthesizer of the voice and music according to the present invention. This synthesizer in FIG. 13 is illustrated to implement the mixing on a client-based terminal. The synthesis unit (20) and the database (30) shown in FIG. 1 are included. The database (30) can be replaced by a communication network, such as internet to download music files.

A control unit (100) performs a general control function in synthesis of the voice and music.

A filtering unit (160) samples the analog voice and converts the sampled analog voice signals to digital signals. The Fourier transform is applied to the converted signals such that the time-based data is converted into frequency-based data and high or low frequencies, that human cannot produce, are blocked so as to input only human's voice. Such a digital processing can be done through analog filtering. That is, the filtering unit (160) removes the white noise, such as a circuit noise or a peripheral noise, that comes in regularly so that pure voice required to be synthesized into the music are inputted. For example, in a space where fans are turning, a fan noise can be detected even though no voices are heard. In this case, a difference between a real voice input part and a noise input part can be detected and the white noise can be removed by using such a voice difference. First input signal (s) for a period of time T and second input signals (s+S) for a period of time T+t can be used to remove the white noise (s) that comes in regularly. Also, the filtering unit can be used to remove a peak noise. When a loud sound (big signal that is over a regular amplitude) abruptly comes in on an axis of time, such a loud sound can be removed by filtering off the corresponding peaks in the filtering unit.

A voice separating unit (140) separates the entire voice data into a plurality of voice elements according to the whole time frame of the input voice and a voice silent part from a voice silent control unit (130). For example, when a voice is inputted shown in FIG. 10, time frame can be determined, considering part B of the voice silent part as a separate position and the voice can be divided into front and rear silent parts with part B as the central figure. When there is no voice silent part as shown in part B, part A or B can be considered as the separating reference. The separation of the input voice is to control volume of the music and the separation can be done automatically or manually. Also, the separation is carried out by the user's input orders. For example, pressing number 1 button of a handheld phone can be used for inputting a first voice element and pressing number 2 button can be used for inputting a second voice element. Further, it is possible to input the voice elements in compliance with comment information.

When a length of the input voice signal is shorter than a predetermined length, the voice silent control unit (130) can recognize it as a voice silent part which is not inputted by the user. In determining the voice silent part, a certain length of the voice silent part should be recognized as a blank, as well as existence of the signal. According to the length of a voice silent input, the blank should be detected. The voice silent control unit (130) aids the separation of input voice. That is, as shown in FIG. 10, after separating the input voice, the voice silent control unit (130) eliminates a voice silent part at the front and rear part of the voice element (rear and front part of the first and second elements, respectively) and also eliminates an portion of the voice silent part in the middle of the input voice to short the silent time and to form shortened silent parts (A′ and C′).

A storage unit (120) stores the voice input, the separated voice, the background music and the synthesized file are stored therein.

A synthesis unit (150) synthesizes the stored voice and music through a digital signal processing under the control of the control unit (100). Synthesized voice and music volumes are controlled. The volume level, which is lower or higher than an average level, is respectively amplified and reduces to help hearing. Beginning part of the music volume will remain untouched or the volume control can be fade in. Also, the volume control can be fade out at the end. a down control will be used in the beginning of the voice elements and a up control will be used at the end of the voice elements to recover an original volume setting. Fast forward, fast rewind and rewind functions can be used for convenience' sake.

When the length of the stored voice exceeds that of the music, the same music can be repeated or other music can be mixed on the background.

Hereinafter, an embodiment of the present invention will be described about separation of the voice input into two voice elements and synthesis the two voice elements and two music sources referring to the FIG. 10, 11, 12.

When the user stores his voice as shown in FIG. 10, the white noise in the input voice is removed by the filtering unit (160) and the filtered voice is temporarily stored. The voice separating unit (140) detects the voice silent part through the voice silent control unit (130) and separates the stored voice into two voice elements based on the length of the stored voice. Also, if the voice silent part is longer than a predetermined length, it is shortened by the voice silent control unit (130) to control non existent voice (voice silent part).

FIG. 11 illustrates a music for synthesis. In FIG. 11, points 1 to 9 of time indicates down points (DP) where the voice elements can be synthesized and the volume of music can be down. The down points can be established at a changing point of the mood of the music or a starting point of signer's outstanding singing ability, a refrain, the lyrics (first, second or third part), a sentence, a word, a solo, a concert, a chapter or a part. These down points can be established to have a few seconds or tens of seconds.

As shown in FIG. 10, after completing the voice separation, the voice and music are synthesized by a synthesizer (150).

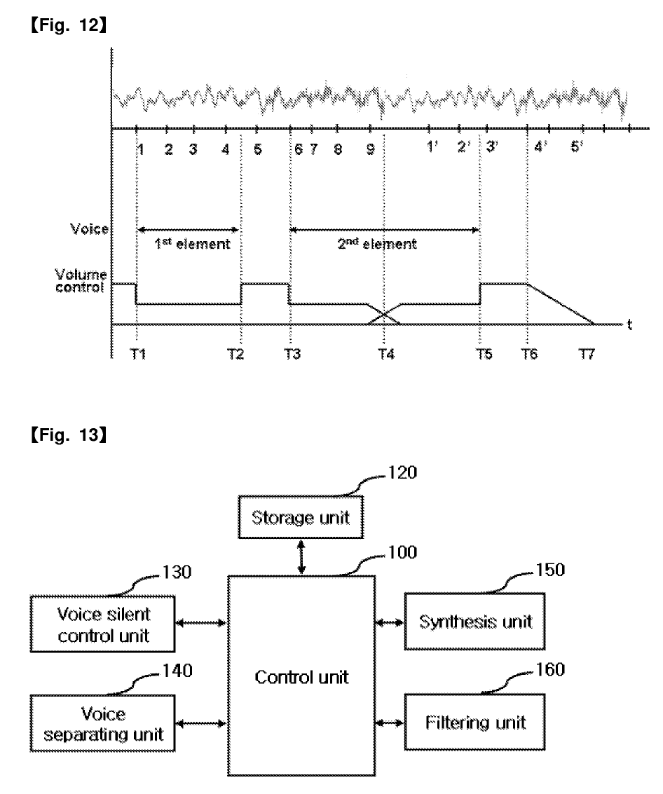

Referring to FIG. 12, a synthesis of a first voice element is carries out at point T1 where a first down point (1) is positioned. At this time, a music volume is down-controlled at point T1 where the first voice element starts and it is up-controlled at point T2 where the first voice element ends. In view of the music, the synthesis of the first voice element is completed between down points 4 and 5. If the time difference between the ending point of the synthesis of the first voice element and down point 6 is shorter than a predetermined amount of time, a synthesis of a second voice element may start at down point 6. At point T3, a music volume is down-controlled. Even if the time difference between the first and second voice elements can be controlled based on the down points, the synthesis of the second voice element can be controlled at a specific point other than the above-mentioned down points. For example, the synthesis of the second voice element can start after 20 seconds from the completion of the synthesis of the first voice element. Preferably, the synthesis of the second voice element should be carried out at the down point to maximize the mixing effects on the synthesis.

On the other hand, when the length of the music is shorter than that of the voice element such that the music ends at point T4, other music data should be subsequently synthesized. At this time, the starting part of a second music is overlapped with the ending part of the first music to have no outstanding volume variation. As illustrated at part E of FIG. 9, a cross-coupled volume control is applied to the ending and starting parts of the first and second music elements so that the amount of volume level at point T4 is kept constant somewhat.

At point T5 where the synthesis of the second voice element is terminated, the music volume is up-controlled. Thereafter, the music is faded out from down point 3′ after a predetermined time or from down point 4′ after the lapse of the predetermined time.

FIG. 14 illustrates a service using the synthesizing procedure of the voice and music according to the present invention.

At step 200, if a user is coupled to a communication network (mobile communication network, wire communication network or internet), an identification procedure for the user is processed. If the user requires a synthesis service, go to step 220, or not go to step 211 to execute other procedures to be settled previously.

At step 220, the user inputs his voice via the coupled communication network. At this time, the voice input can be carried out by a handheld phone, a wire telephone, a microphone installed in a computer. As set forth above, the voice input can be directly divided by the user into several elements according to information from a service provider or a server can divide the entire voice into a plurality of voice elements referring to the length of the voice and a silent part. Only one voice element can be used in the synthesis. At step 230, the synthesis of the divided voice elements is carried out by the synthesizing unit (20) using the above-mentioned down points and introduction, bridge and ending elements of the music. At step 240, the required service is confirmed by the user and a billing for the service is executed. For example, if the synthesized sound is a voice message, information about the transmission time of the message and a receiver thereof may be input in the server. At step 250, the corresponding message is transmitted to the receiver and the confirmation of the transfer is sent to the user. In case where the synthesized sound is a voice message, the service provider can call the receiver on time reserved by the user and transmits an information message to him, for instance, “This is a DJ mail message from 1234 to 5678.”

When the synthesized sound is a bell sound or a coloring (which is heard music to a caller), it can be set up in the user's phone or the telephone exchange or it can be downloaded on the phone via a bell sound download function. The set-up information is sent to the user in a short message.

### INDUSTRIAL APPLICABILITY

As apparent from the above, the synthesis according to the preset invention makes the user have the maximum effectiveness of the mixing by adaptively synthesizing the voice and music. This excellent mixing is carried out with an automatic volume control in the synthesizer.

1. A system for synthesizing voice and music comprising;
a receiver for receiving the voice from a user;
a database for storing a plurality of music data; and
a synthesizing means for constituting at least one voice element from the received voice, controlling a volume of the music according to a silent part of the received voice, a starting part or an ending part of the voice element, synthesizing and saving the voice element and the volume-controlled music.

2. The system in accordance with claim 1, wherein the voice element is constituted based on the silent part of the received voice or a part defined by the user.

3. A system for synthesizing voice and music comprising;
a receiver for receiving the voice from a user;
a database for storing individually separated music elements which constitute the music; and
a synthesizing means for constituting voice elements from the received voice, synthesizing the voice elements and the music elements according to a silent part of the received voice, a starting part or an ending part of the voice elements, and saving the synthesized voice elements and the music elements.

4. The system in accordance with claim 3, wherein the each of voice elements is constituted based on the silent part of the received voice or a part defined by the user.

5. A method for synthesizing voice and music comprising the steps of:
a) receiving the voice from a user;
b) constituting at least one voice element from the received voice;
c) controlling a volume of the music according to a silent part of the received voice, a starting part or an ending part of the voice element; and
d) synthesizing the volume-controlled music and the voice element.

6. The method in accordance with claim 5, wherein the voice element is constituted based on the silent part of the received voice or a part defined by the user.

7. A method for synthesizing voice and music, comprising the steps of:
a) receiving the voice from a user;
b) constituting at least one voice element from the received voice;
c) controlling a synthesizing position of the voice element and a music element according to a silent part of the received voice, a starting part or an ending part of the voice element; and
d) synthesizing the voice elements and the music element.

8. The method in accordance with claim 8, wherein the voice element is constituted based on the silent part of the received voice or a part defined by the user.

9. A service method for synthesizing voice and music, comprising the steps of:
a) receiving the voice from a user;
b) constituting at least one voice element from the received voice based on the silent part of the received voice or a part defined by the user;
c) synthesizing the voice element and the music;
d) receiving service information about the synthesized voice element and music; and
e) servicing the synthesized voice elements and music according to the service information.

10. The method in accordance with claim 9, wherein the step c) includes the step of,
f) synthesizing the voice element to an introduction part of the music wherein a volume of the music is down-controlled between beginning and ending points of the voice element;
g) fade-out controlling the volume of the music after predetermined time interval from the ending point of the voice element.

11. The method in accordance with claim 9, wherein a voice silent part included in the received voice is shortened when a time length of the voice silent part is longer than a predetermined time.

12. The method in accordance with claim 9, wherein the received voice is separated into a plurality of voice elements based on a silent voice part or a time length of the received voice.

13. A service method for synthesizing voice into music, comprising the steps of:
a) receiving the voice from a user;
b) constituting at least one voice element from the received voice based on the silent part of the received voice or a part defined by the user;
c) synthesizing the voice element and a music element, wherein the music element is one of parts which constitute the music;
d) receiving service information about the synthesized voice element and music element; and
e) servicing the synthesized voice element and music element according to the service information.

14. The method in accordance with claim 13, wherein the step c) includes the steps of,
f) down controlling a volume of the music element at a part of the voice element;
g) fade-out controlling the volume of the music after a lapse of a predetermined time from the ending point of the voice element.

15. The method in accordance with claim 13, wherein the silent part of the received voice is shortened when a time length of the silent part is longer than a predetermined time.

16. The method in accordance with claim 13, wherein the received voice is separated into a plurality of voice elements based on the silent part or a time length of the received voice.

17. The method in accordance with claim 13, wherein the music element is one of introduction, bridge and ending elements.

18. The method in accordance with claim 17, wherein the introduction or bridge or ending element includes a volume down part for being synthesized with the voice element.

19. A method for synthesizing voice into music, comprising the steps of:
a) receiving the voice from a user;
b) starting a synthesis of a beginning part of the received voice and the music according to a point information of the music, wherein the point information is indicative of a synthesis of the voice; and
c) saving the synthesized voice and the music.

20. A method for synthesizing voice into music, comprising the steps of:
a) receiving the voice from a user;
b) constituting at least one voice element from the received voice,
c) starting a synthesis of a beginning part of the voice element and the music according to a point information of the music, wherein the point information is indicative of a synthesis of the voice; and
d) saving the synthesized voice element and the music.

21. The method in accordance with claim 20, wherein the step c) is performed using a predetermined time interval between the voice elements or at least one point according to the point information.

22. The method in accordance with claim 20, wherein the music is repeated or is mixed with other music data when the voice is longer than the music.

23. A service method for synthesizing voice into music, comprising the steps of:
a) receiving the voice from a user;
b) constituting at least one voice element from the received voice, wherein the voice element is constituted based on the silent part of the received voice or a part defined by the user;
c) synthesizing the voice element and the music;
d) receiving service information about the synthesized voice element and the music;
e) servicing the synthesized voice element and a music element according to the service information, wherein the music element is one of parts which constitute the music; and
f) sending resulting information of the step e) to the user.
